(19) United States
(12) Patent Application Publication
(10) Pub. No.: US 2019/0152655 A1
(43) Pub. Date: May 23, 2019

(54) CONTAINER AND CAP DEVICE FOR A CONTAINER

(71) Applicant: Simon Karlik, (US)

(72) Inventor: Brendan Hingston Lake, Venice, CA (US)

(21) Appl. No.: 16/163,324

(22) Filed: Oct. 17, 2018

(30) Foreign Application Priority Data
Nov. 20, 2017 (AU) 2017904688

(51) Int. Cl. B65D 41/04; B65D 1/02; B65D 81/38; B65D 51/24; A47J 41/02

(52) U.S. Cl. CPC B65D 41/0414; B65D 1/0215; A47J 41/022; B65D 51/242; B65D 81/3846

(57) ABSTRACT

A cap device includes a body configured to allow the cap device to be removably coupled to a neck of a body of a container. The cap device further includes a seal mounted to the body and configured to form a watertight seal at an opening of the neck when the cap device is coupled to it, so as to preclude a fluid and/or foodstuff contained within an internal volume of the container from contacting the body.

### TECHNICAL FIELD

The present invention relates to a container and a cap device for a container for containing fluids and/or foodstuffs therein.

The invention has been developed primarily for use with a container for containing foodstuff and/or fluid for human consumption and will be described hereinafter with reference to this application.

The following discussion of the background to the invention is intended to facilitate an understanding of the invention. However, it should be appreciated that the discussion is not an acknowledgement or admission that any of the material referred to was published, known or part of the common general knowledge in Australia or any other country as at the priority date of any one of the claims of this specification.

### BACKGROUND OF INVENTION

Containers used for containing/storing foodstuffs and/or fluids for human consumption are oftentimes manufactured from plastic materials due to their low cost and the ease with which such plastics can be formed into a desired shape.

However, recent scientific evidence suggests that certain compounds used in the manufacture of said plastic materials such as stabilizers, plasticizers and the like, can leach from the plastic material and subsequently contaminate the foodstuff and/or fluid contained within the container. In particular, various compounds such as for example, Bisphenol-A (BPA) and a number of phthalate compounds, are widely agreed to present a health risk and have been declared to be toxic substances by some governmental authorities. These compounds are increasingly being banned and removed from containers used for containing fluid and/or foodstuff for human consumption.

To this end, manufacturers have been exploring ways to avoid the use of plastic material in the manufacture of these containers. For instance, some manufacturers are manufacturing containers from metal such as stainless steel or aluminium. However, it is often the case that the cap device used to seal the metal container is made from a plastic material, which can contact the contents contained within the metal container thereby defeating the purpose of using metal.

In the limited number of cases where the cap device is also made of metal, particularly those cases where the cap device and the neck of the metal container are configured with a complementary screw thread, the action of metal on metal as the cap device is screwed onto the neck of the metal container is ungainly, and often results in a poor sealing capability.

An additional point of concern with the use of aluminium in the manufacturing process is that manufacturers often line the internal surface of the aluminium container with a polymer film to prevent the aluminium from tainting the foodstuffs and/or fluids within the aluminium container. However, such polymer films are often produced using BPA which has been shown to leach from the polymer film, thereby defeating the purpose of using aluminium.

To cap it all, the large cost associated with the use of metals, particularly food grade metals, in the manufacturing process for metal containers, must invariably be passed onto the consumer.

The present invention seeks to provide a container and a cap device for a container for containing fluids and/or foodstuffs therein, which will overcome or substantially ameliorate at least some of the deficiencies of the prior art, or to at least provide an alternative.

### SUMMARY OF INVENTION

According to a first aspect of the present invention there is provided a cap device, including:

a body member configured to allow the cap device to be removably coupled to a neck of a container body; and

a seal member mounted to the body member and configured to form a watertight seal at an opening of the neck when the cap device is coupled thereto to preclude a fluid and/or foodstuff contained within an internal volume of the container body from contacting the body member.

Preferably, the neck of the container body is shaped to define a constriction at the opening, and wherein the seal member includes a lower portion configured to engage with and be snugly received by the constriction to form said watertight seal.

Preferably, the body member includes a lower body portion configured to engage the neck of the container body, wherein the neck and the lower body portion include complementary coupling means to allow the cap device to be removably coupled to the neck.

Preferably, the complementary coupling means takes the form of a threaded portion disposed around an internal surface of the neck of the container body and a complementary threaded portion disposed around an external surface of the lower body portion for facilitating screw threaded engagement therebetween.

Preferably, the seal member includes an upper portion configured to engage with and be supported by the lower body portion.

Preferably, the body member is hollow and the upper portion of the seal member is configured to locate within the lower body portion and be retained therein by an interference fit.

Preferably, the seal member further includes a recessed portion disposed substantially between the upper portion and the lower portion that is configured to receive a terminal end portion of the lower body portion by said interference fit.

Preferably, the cap device further includes an insert member configured to locate within the hollow body member to engage with and cause the upper portion of the seal member to abut against a ledge defined by the terminal end portion of the lower body portion according to said interference fit.

Preferably, the cap device further includes a cap member configured to mount to an upper body portion of the body member to enclose the insert member substantially within the hollow body member between the cap member and the seal member.

Preferably, the seal member is manufactured from a food grade material.

In one embodiment, the food grade material is a rubberised material selected from the group consisting of a silicone rubber and a fluoropolymer.

Preferably, the body member is manufactured from an engineering plastic material.

In one embodiment, the engineering plastic material is selected from the group consisting of polypropylene, polyethylene, polyethylene terephthalate (PET), polycarbonate and polyvinyl chloride.

Preferably, the cap device further includes a handle operably coupled to the body member.

According to a second aspect of the present invention there is provided a, including:

a container body having a base and at least one wall generally upstanding from the base that terminates in a neck with an opening; and

a cap device having a body member configured to allow the cap device to be removably coupled to the neck of the container body, and a seal member mounted to the body member and configured to form a watertight seal at the opening of the neck when the cap device is coupled thereto to preclude a fluid and/or foodstuff contained within an internal volume of the container body from contacting the body member.

Preferably, the neck of the container body is shaped to define a constriction at the opening, and wherein the seal member includes a lower portion configured to engage with and be snugly received by the constriction to form said watertight seal.

Preferably, the body member is manufactured from an engineering plastic material.

In one embodiment, the engineering plastic material is selected from the group consisting of polypropylene, polyethylene, polyethylene terephthalate (PET), acrylonitrile butadiene styrene (ABS), polycarbonate and polyvinyl chloride.

Preferably, the seal member is manufactured from a food grade material.

In one embodiment, the food grade material is a rubberised material selected from the group consisting of a silicone rubber and a fluoropolymer.

In one embodiment, the container body is manufactured from a food grade metal selected from the group consisting of stainless steel, copper, and any alloy thereof.

In one embodiment, the container body is single walled.

In one embodiment, the container body is double-walled.

In one embodiment, the container includes insulation material disposed substantially between the walls of the double-walled container body.

In one embodiment, the container includes a partial vacuum substantially between the walls of the double-walled container body.

Other aspects of the invention are also disclosed.

### BRIEF DESCRIPTION OF DRAWINGS

Notwithstanding any other forms which may fall within the scope of the present invention, preferred embodiments of the invention will now be described, by way of example only, with reference to the accompanying drawings in which:

FIGS. 1 to 4 show various views of a cap device according to a preferred embodiment of the present invention;

FIGS. 5 and 6 each show a perspective view (in exploded form) of the cap device of FIGS. 1 to 4 (with the handle removed for clarity);

FIGS. 7 and 8 each show a perspective view of a body member of the cap device of FIGS. 1 to 4;

FIGS. 9 and 10 each show a perspective view of a seal member of the cap device of FIGS. 1 to 4;

FIGS. 11 to 14 each show a perspective view of an insert member of the cap device of FIGS. 1 to 4;

FIGS. 15 and 16 each show a perspective view of a cap member of the cap device of FIGS. 1 to 4;

FIG. 17 shows a perspective view of a container according to another preferred embodiment of the present invention, in which the container includes a container body and the cap device of FIGS. 1 to 4 coupled to a neck of the container body;

FIGS. 18 and 19 each show a perspective view of the container body of FIG. 17;

FIG. 20 shows a partial cross sectional view (taken along a vertical plane X-X) of the container body of FIG. 18 and of the cap device of FIGS. 1 to 4, before coupling the cap device to a neck (internal thread removed for clarity) of the container body; and

FIG. 21 shows a partial cross sectional view (taken along a vertical plane X-X) of the container body of FIG. 18 and of the cap device of FIGS. 1 to 4, after coupling the cap device to the neck (internal thread removed for clarity) of the container body.

### DETAILED DESCRIPTION

It is to be understood that the following description is for the purpose of describing particular embodiments only and is not intended to be limiting with respect to the above description.

The present invention is predicated on the finding of a cap device 10 for a container 200, and more specifically, a cap device 10 removably coupling to a neck 205 of a container body 230 of the container 200, in which the cap device 10 and an opening 215 at the neck 205 are suitably configured to preclude certain plastic containing parts of the cap device 10 that could otherwise leach undesirable compounds, from contacting and thus contaminating any foodstuff and/or fluids that may be contained within an internal volume 250 of the container body 230.

Cap Device

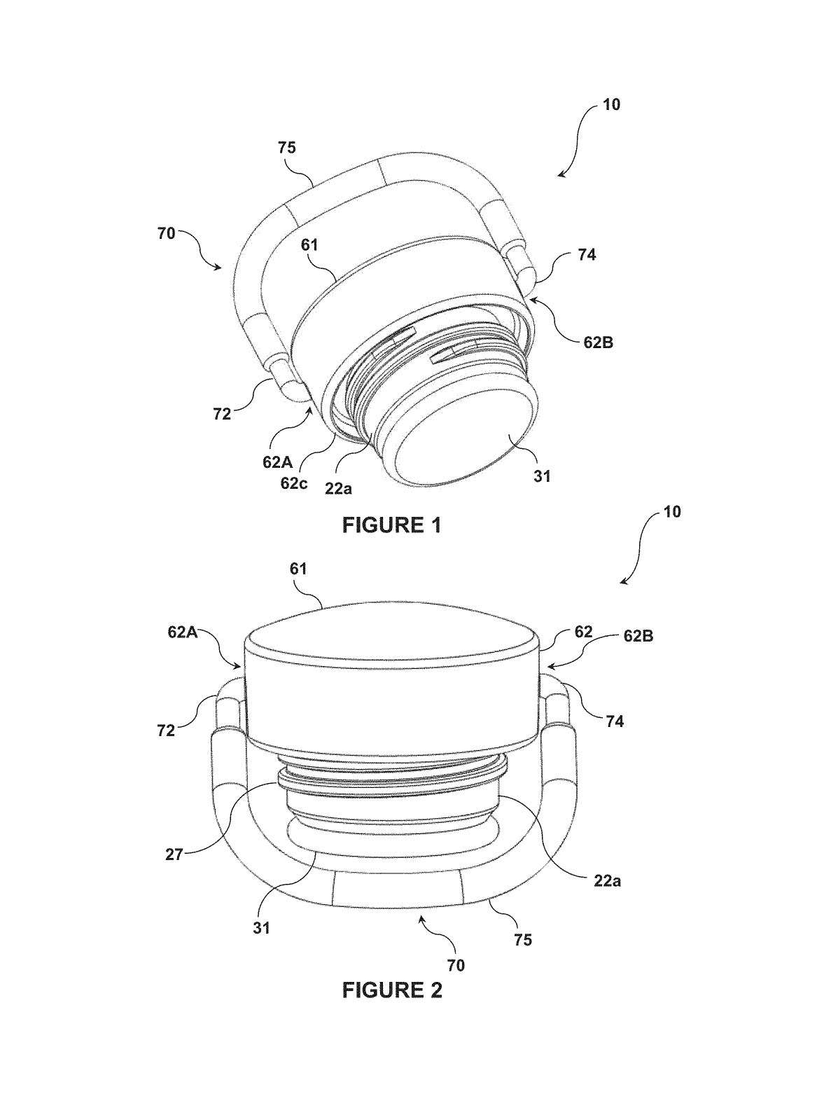

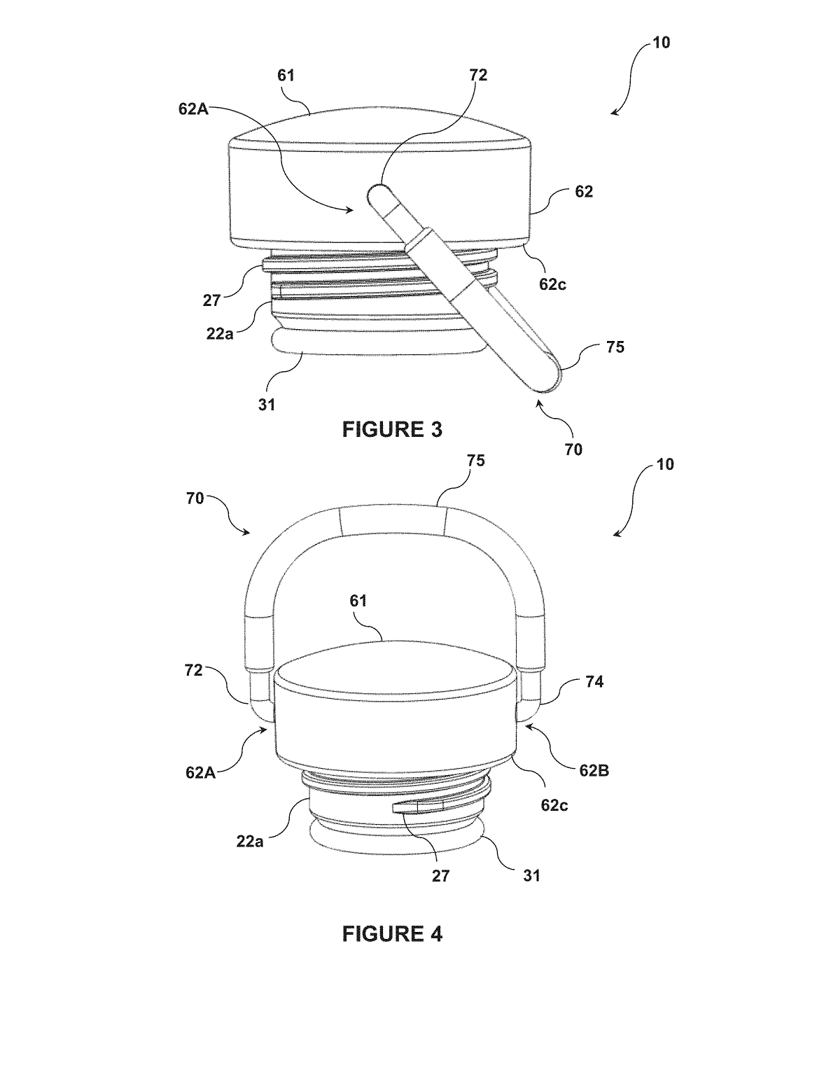

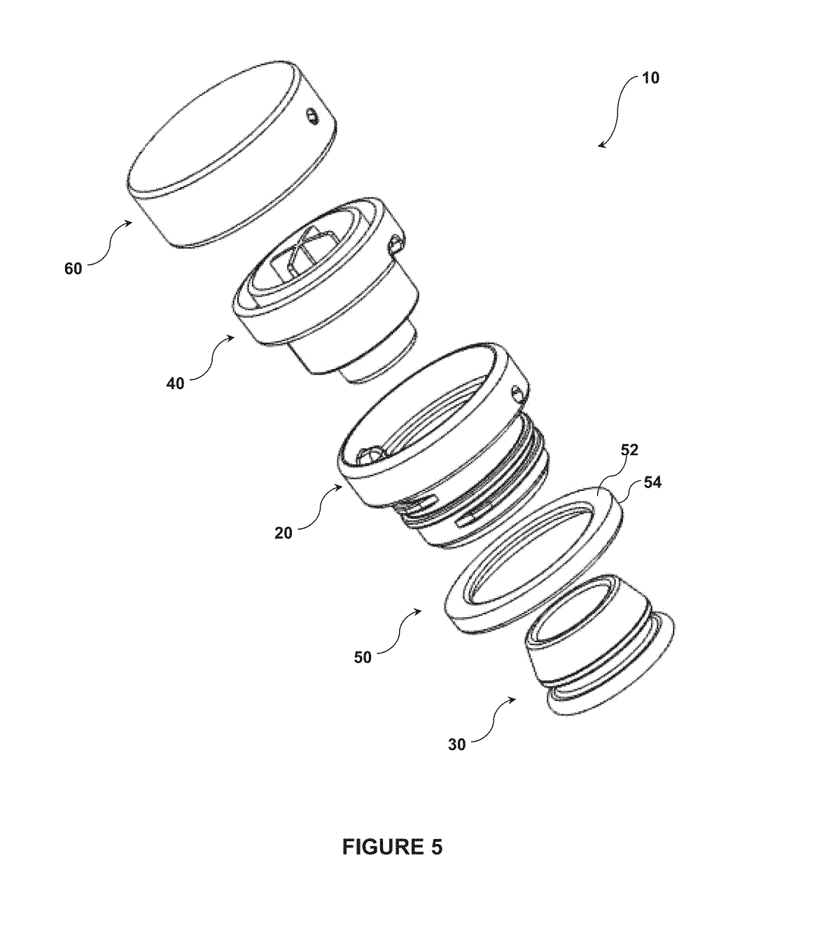

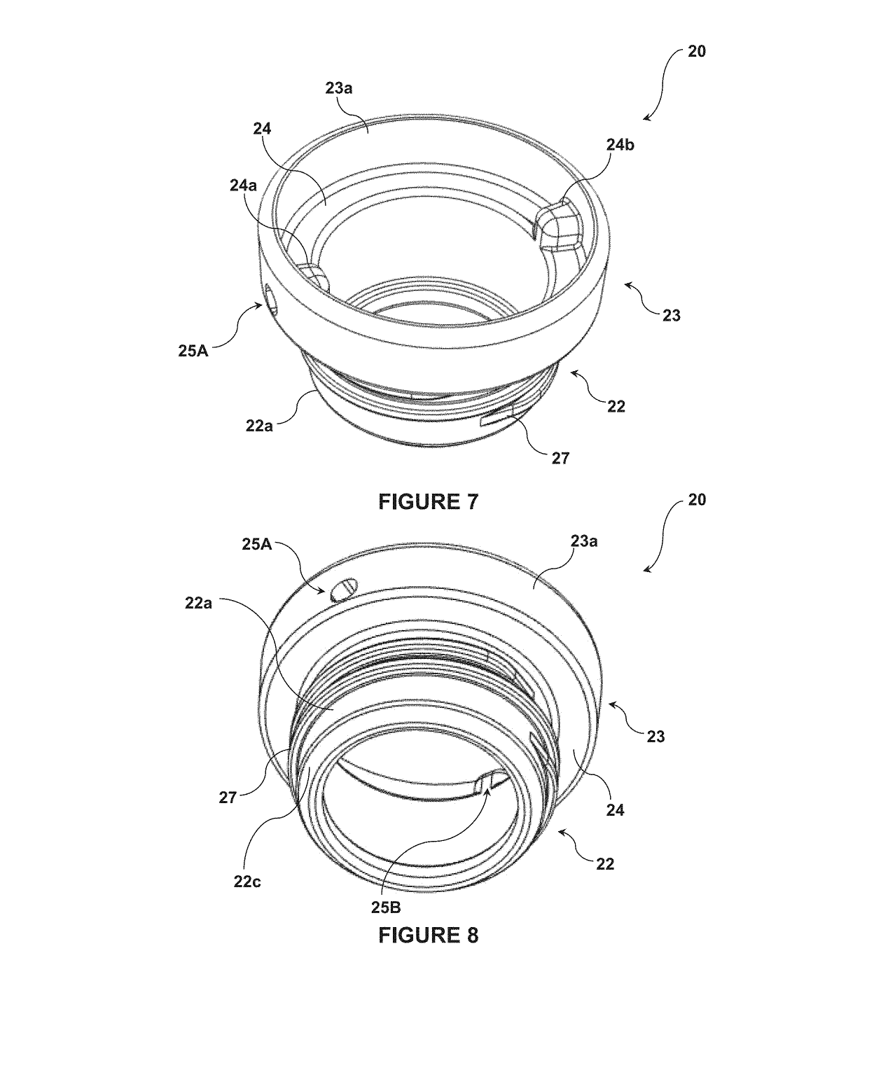

Referring to FIGS. 1 to 6 there is provided a cap device 10 according to a preferred embodiment of the present invention, together with the various components of the cap device 10 shown in FIGS. 7 to 16.

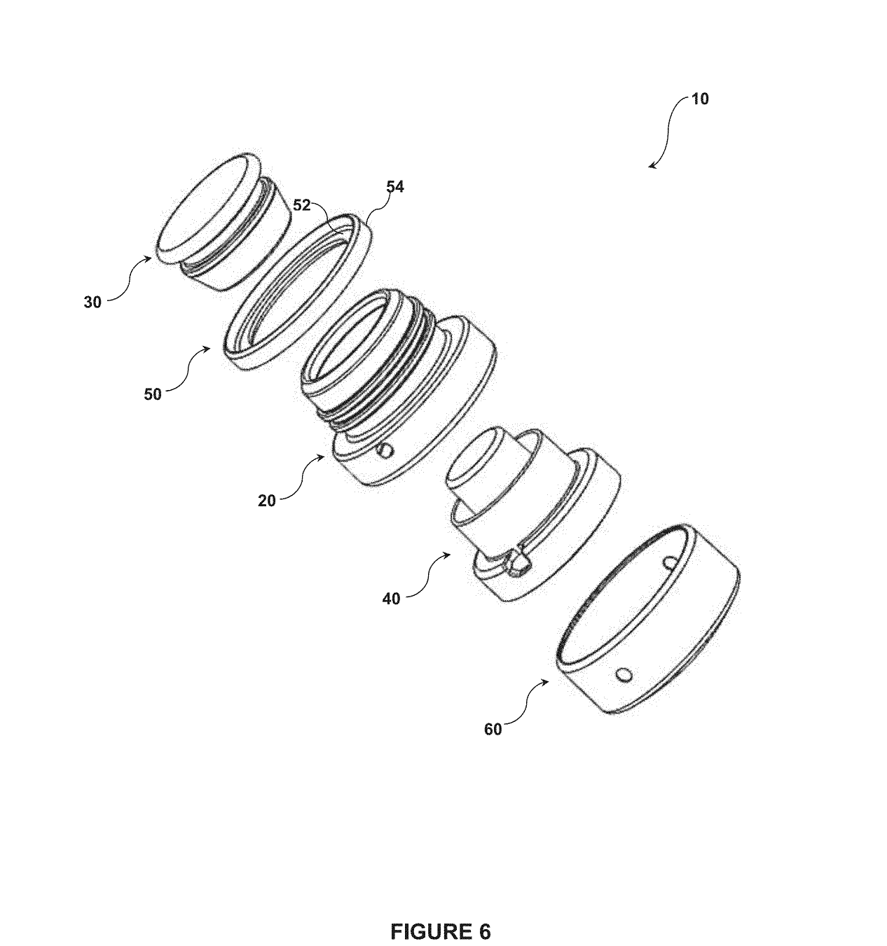

In its simplest form, and as shown in exploded form in FIGS. 5 and 6, the cap device 10 is comprised of a series of components including a body member 20, a seal member 30, an insert member 40, a sealing ring 50 and a cap member 60 that are all assembled together in a manner described in more detail below. Optionally, and as shown in FIGS. 1 to 4, a handle 70 may also be coupled to the cap device 10 for easy of carrying,

The various components of the cap device 10 will now be described with reference to the associated figures.

Body Member

Referring firstly to FIGS. 7 and 8, the body member 20 takes the form of a generally cylindrical body comprising of two interconnected portions arranged concentrically with respect to each other, specifically a lower body portion 22 having a diameter as defined by a first wall 22a and an upper body portion 23 having a larger diameter as defined by a second wall 23a. The difference in the diameters of the upper body portion 23 and the lower body portion 22 interconnected thereto defines a first ledge 24 interconnecting the first wall 22a and the second wall 23a. The upper body portion 23 includes a pair of apertures 25A, 25B that extend substantially through the second wall 23a at opposing sides thereof and terminate in a corresponding enclosed portion 24a, 24b located at the first ledge 24.

As will become apparent from the description below, the lower body portion 22 of the body member 20 is configured to engage with and be removably coupled to the neck 205 of the container body 230. In this respect, a screw thread 27 is formed at an external surface of the lower body portion 22 that is complementary to a screw thread 220 formed at the internal surface of the neck 205 for facilitating screw threaded engagement therebetween.

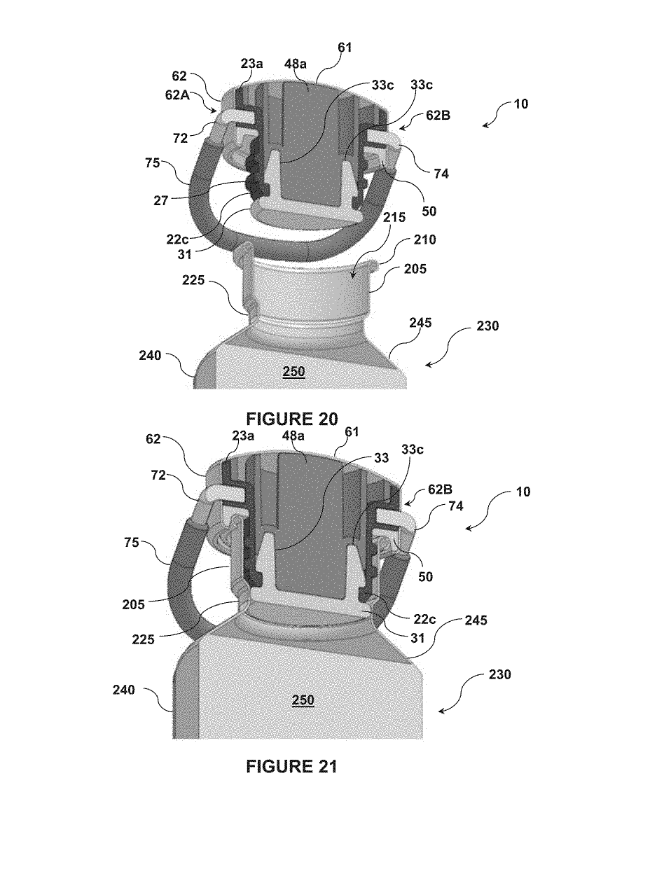

As shown in FIGS. 7 and 8, and more specifically in FIGS. 20 and 21, a terminal end of the first wall 22a defining the lower body portion 22 is angled slightly inwards towards a centre of the lower body portion 22 to define an engaging portion 22c which, as will be described in more detail below, is configured to locate within a recessed portion 35 of the seal member 30.

It will be appreciated by persons of ordinary skill in the relevant art, that since the configuration of the cap device 10 and the neck 205 of the container body 230 precludes the body member 20 from contacting, and thus contaminating any foodstuff and/or fluid contained within the internal volume 250 of the container body 230 when the cap device 10 is coupled to the neck 205, the body member 20 can be manufactured from any suitable engineering material. To this end, it is entirely possible to manufacture the body member 20 from a plastic material that may be prone to leaching undesirable compounds without fear of the plastic body member 20 contacting and contaminating foodstuffs and/or fluids contained within the container body 230.

In this respect, the engineering material used in the manufacture of the body member 20 may be a plastic material selected from the group consisting of polypropylene, polyethylene, polyethylene terephthalate (PET), acrylonitrile butadiene styrene (ABS), polycarbonate and polyvinyl chloride.

Seal Member

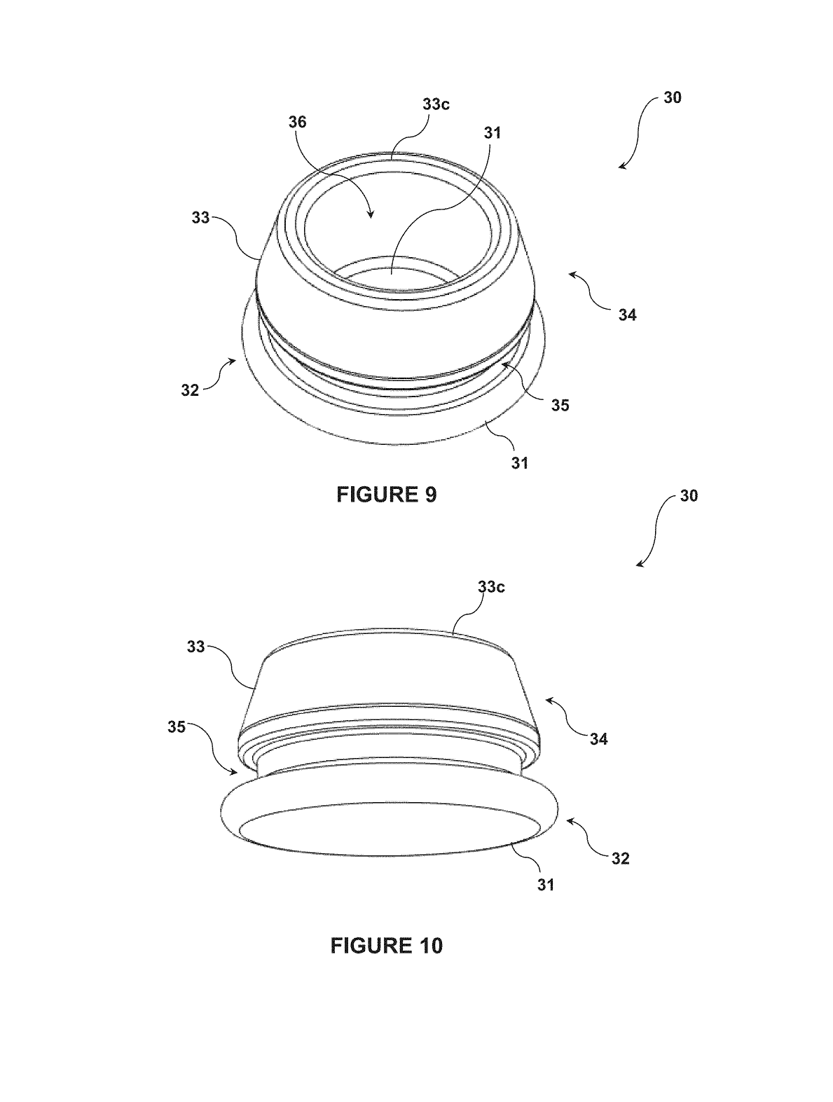

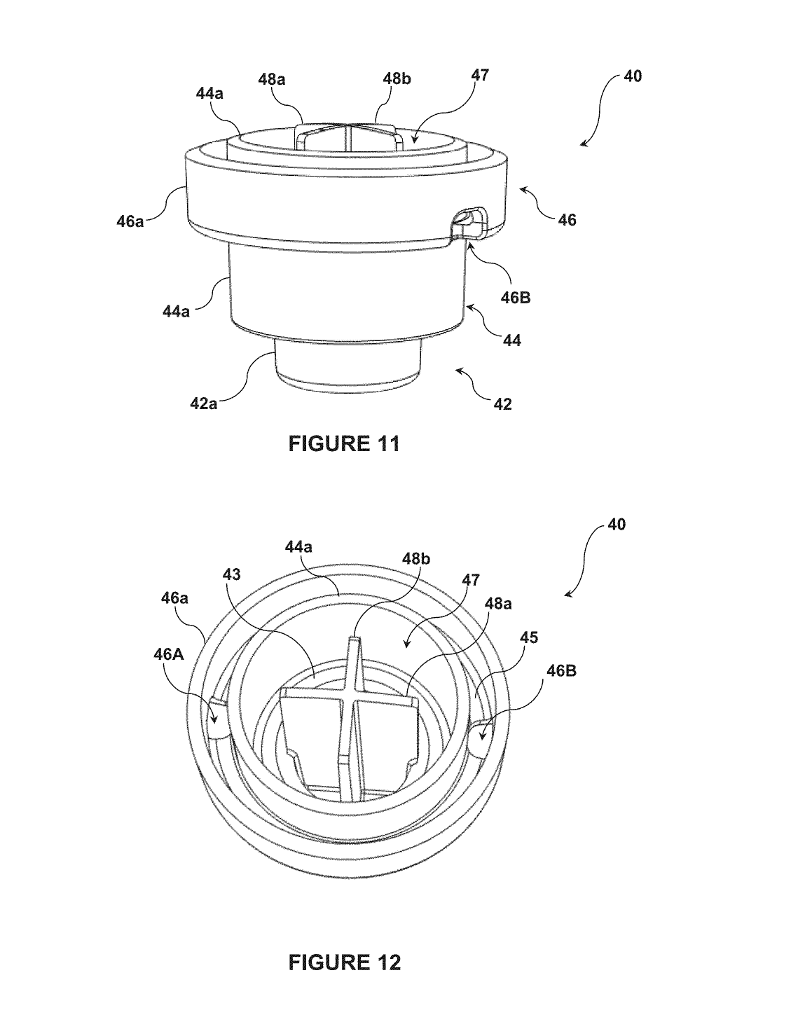

Referring next to FIGS. 9 and 10, the seal member 30 takes the form of a plug having a generally circular base 31 of a first diameter and a wall 33 upstanding from a location inset from a periphery of the base 31 such that the wall 33 is generally circular and concentric with the base 31.

Referring specifically to the partial cross sectional view in each of FIGS. 20 and 21, the wall 33 extends a short distance from the base 31, whereupon the thickness of the wall 33 increases in an outwardly direction to define an external diameter that is just less than the first diameter associated with the base 31. The thickness of the wall 33 then gradually decreases as the wall 33 extends further away from the base 31, whereupon the wall 33 terminates at an end 33c distal from the base 31 having a thickness that is generally the same as the narrowest portion of the wall 33 (hereinafter referred to as a recessed portion 35 of the seal member 30) adjacent to the base 31 (hereinafter referred to as a lower portion 32 of the seal member 30). The resulting sloped portion of the wall 33 disposed between the recessed portion 35 and the terminal end 33c of the wall 33 is, hereinafter, referred to as an upper portion 34 of the seal member 30. The internal diameter of the wall 33 defines an internal volume 36 of the seal member 30.

The seal member 30 is manufactured from a food grade material that is sufficiently flexible to form, as will be described in more detail below, a good watertight seal against a constriction 225 formed at the opening 215 of the neck 205 of the container body 230. Suitable food grade materials include, but are not limited to: silicone rubber and certain fluoropolymers such as those sold commercially by DuPont Performance Elastomers under the trade name, Viton™.

Insert Member

Referring next to FIGS. 11 to 14, the insert member 40 takes the form of a generally cylindrical body comprising of three interconnected portions arranged concentrically with respect to each other, specifically, a base portion 42 having a generally circular base 41 and a first wall 42a upstanding from the base 41 and defining a first diameter, a central portion 44 having a diameter as defined by a second wall 44a, and a skirt portion 46 having a diameter as defined by a third wall 46a. The difference in the diameters between the base portion 42 and the central portion 44 defines a first ledge 43 interconnecting the first wall 42a and the second wall 44a, and the difference in the diameters between the central portion 44 and the skirt portion 46, defines a second ledge 45 interconnecting the third wall 46a and the second wall 44a at a position generally above a midway point along a length of the second wall 44a.

As shown in, for example, FIGS. 11, 20 and 21, the height of the third wall 46a defining the skirt portion 46 falls just short of the height of the second wall 44a defining the central portion 44.

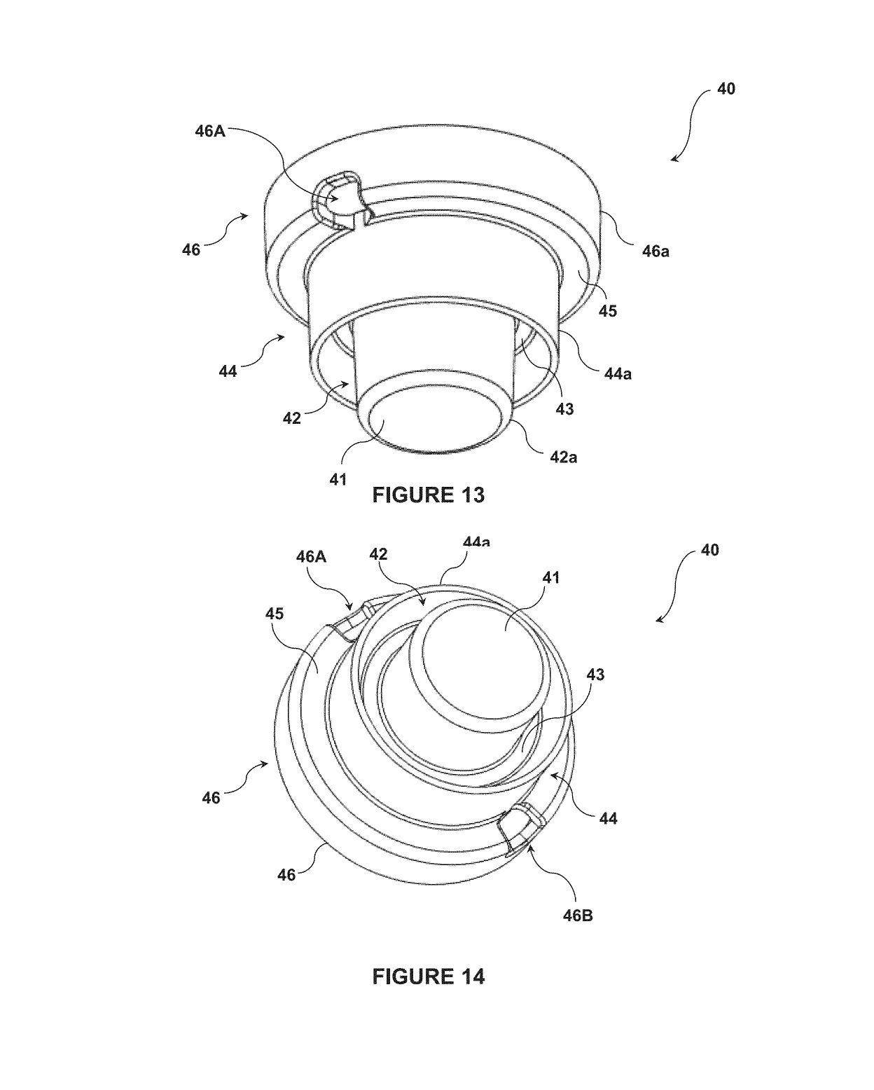

As shown in FIGS. 13 and 14, the base portion 42 of the insert member 40 is closed at a first end thereof by virtue of the base 41, and then as shown in FIGS. 11 and 12, opens out at an opposing end thereof into an internal volume 47 of the central portion 44. The insert member 40 is further formed with a pair of crossed vanes 48a, 48b to afford the insert member 40 with additional structural rigidity. The pair of crossed vanes 48a, 48b are connected at their respective lower ends to an inner surface of the first wall 42a defining the base portion 42 and then extend upwardly from the closed end of the base portion 42 into the internal volume 47 of the central portion 44 to a height that is slightly greater than the height of the second wall 44a.

As shown in FIGS. 11 to 14, The skirt portion 46 includes a pair of apertures 46A, 46B that extend through the third wall 46a at opposing sides thereof and through a corresponding part of the second ledge 45.

As will become apparent from the description below, the insert member 40 is configured to be received substantially within the hollow body member 20 via the upper body portion 23 thereof. By virtue of this arrangement, it is clear that the insert member 40 does not come into contact with any foodstuffs and/or fluids contained with the container body 230. To this end, the insert member 40 may be manufactured from any suitable engineering plastic including but not limited to: polypropylene, polyethylene, acrylonitrile butadiene styrene (ABS), or polycarbonate.

Sealing Ring

As shown in FIGS. 5 and 6, the sealing ring 50 is an annular ring member 52 having an external diameter that conforms largely to the diameter of the upper body portion 23 of the body member 20, and an internal diameter sized to allow the seal member 50 to receive the lower body portion 22 substantially therethrough. The sealing ring 50 has a shallow skirt portion 54 that depends from a periphery of the annular ring member 52.

Cap Member

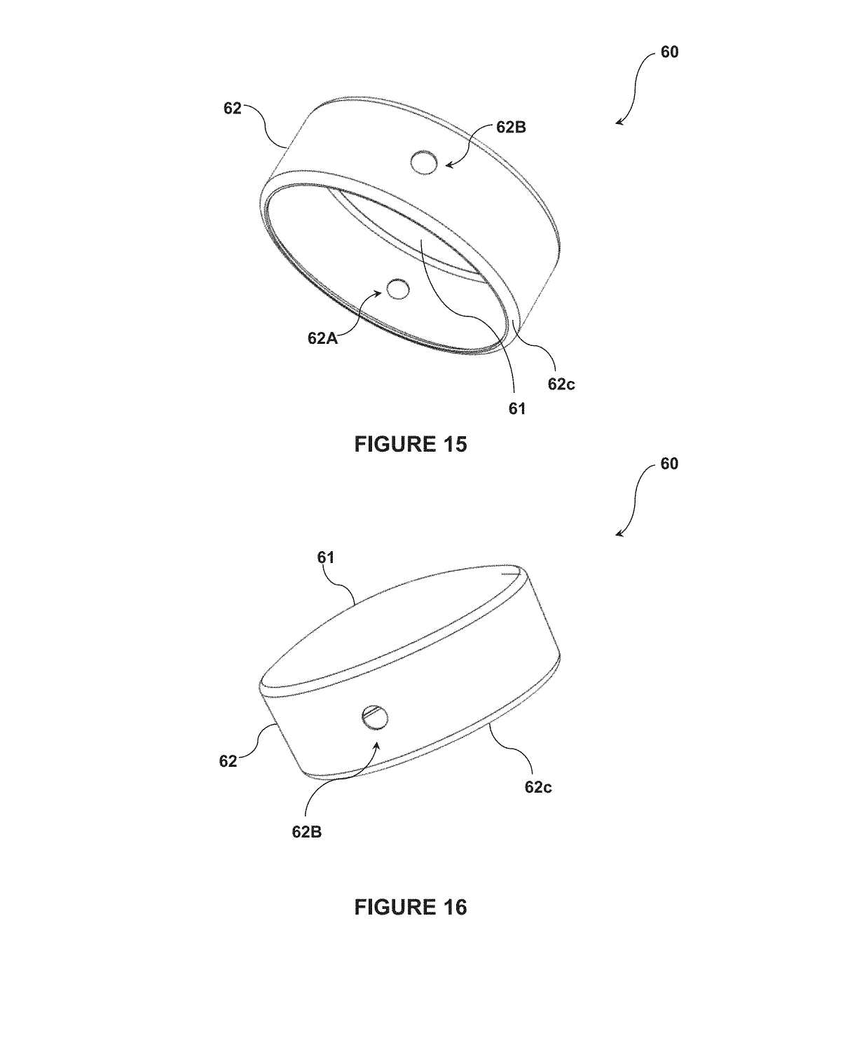

Referring specifically to FIGS. 15 and 16, the cap member 60 includes a generally circular base 61, and a skirt portion 62 depending from a periphery of the base 61, which terminates at an end portion 62c that is angled gently inwards towards a centre of the cap member 60. The base 61 is slightly convex in shape such that the cap member 60 has a slight domed appearance when viewed from above. Extending substantially through opposing sides of the skirt portion 62 is a pair of apertures 62A, 62B, the purpose of which will become apparent from the description below.

Cap Device Assembly

With specific reference to FIGS. 20 and 21, the cap device 10 is assembled according to the steps of the following method.

Firstly, the upper portion 34 of the seal member 30 is located through the lower body portion 22 of the hollow body member 20 such that recessed portion 35 defined between the upper portion 34 and the lower portion 32 of the seal member 30 substantially receives the engaging portion 22c disposed around the internal periphery at the terminal end portion of the first wall 22a of the lower body portion 22.

Secondly, the insert member 40 is located substantially through the upper body portion 23 of the hollow body member 20, such that each of the two apertures 46A, 46B at the upper portion 46 of the insert member 40 are substantially aligned with and receive a corresponding one of the two enclosed portions 24a, 24b located at the first ledge 24 of the body member 20. In this respect, the base portion 42 of the insert member 40 locates substantially within the internal volume 36 of the seal member 30, whereby an underside surface of the ledge 45 at the upper portion 46 of the insert member 40 engages the first ledge 24 of the body member 20, and an underside surface of the ledge 43 at the central portion 44 of the insert member 40, together with a lower end portion of the second wall 44a defining said central portion 44, engage the terminal end 33c of the wall 33 defining the upper portion 34 of the seal member 30 forcing the upper portion 34 of the seal member 30 to abut against an upper surface of a ledge corresponding to the engaging portion 22c received within the recessed portion 35 of the seal member 30.

By virtue of this arrangement, the upper portion 34 of the seal member 30 is thus configured to be retained within the hollow body member 20 by virtue of an interference fit formed between the engaging portion 22c at the terminal end portion of the first wall 22a of the lower body portion 22 of the body member 20 being received snugly within the recessed portion 35 of the seal member 30, while the lower portion 31 of the seal member 30 is located substantially below the engaging portion 22c at the terminal end portion of the first wall 22a of the lower body portion 22.

The sealing ring 50 is then mounted to the lower body portion 22 of the body member 20 such that the annular ring member 52 of the sealing ring 50 abuts snugly against the underside of the ledge 24 at the upper body portion 23 of the body member 20 with the shallow skirt portion 54 of the sealing ring 50 extending in a direction away from the body member 20 in order to engage the outwardly rolled lip 210 of the neck 205 of the container body 230 when the cap device 10 is coupled thereto.

Once the sealing ring 50 is secured in place, either solely via the snug fit against the lower body portion 22 of the body member 20, or in combination with a suitable fixative such as an adhesive being applied between the annular ring member 52 and the underside of the ledge 24, the cap member 60 is then mounted to the upper portion 23 of the body member 20 such that each of the two apertures 62A, 62B is substantially aligned with a corresponding one of the two apertures 25A, 25B at the upper body portion 23 of the body member 20 so as to enclose the insert member 40 substantially within the hollow body member 20 between the cap member 60 and the seal member 30. As shown in FIG. 21, the inwardly angled terminal end portion 62c of the skirt portion 62 of the cap member 60 overlaps the a terminal end portion of the shallow skirt portion 54 of the sealing ring 50, which helps to maintain the sealing ring 50 in place.

Handle

Optionally, and as highlighted briefly above, the cap device 10 may include a handle 70 for use in carrying the container 200 when the cap device 10 is coupled to the neck 205 of the container body 230.

For instance, in the embodiment shown in FIGS. 1 to 4, 17, and more specifically in FIGS. 21 to 22, the container 200 includes a handle 70 that takes the form of a generally U-shaped ring with opposing end portions 72, 74. When the cap device 10 is assembled, the two opposing end portions 72, 74 of the handle 70 are configured to be received through a corresponding one of the two apertures 62A, 62B located on opposing sides of the cap member 60 of the cap device 10.

By virtue of this arrangement, and as is apparent from FIGS. 1 to 4, the handle 70 is configured to pivot freely about the apertures 62A, 62B.

The handle 70 is manufactured from a suitably robust material that is generally resistant to corrosion and can support the weight of a full container 200 without deforming or breaking. In a preferred form, the handle 70 is manufactured from a metal including but not limited to: stainless steel, aluminium or brass.

In other embodiments, the handle 70 may be manufactured from a suitable engineering plastic including but not limited to: polypropylene, polyethylene, acrylonitrile butadiene styrene (ABS), or polycarbonate.

For additional grip, the handle 70 also includes an elongate sleeve 75 received on the U-shaped ring, which is ideally manufactured from a soft plastic, solid foam (for example, a closed-cell or open-cell foam) such as a polyurethane foam, or a rubberised material such as silicone rubber.

Container (Single-Walled Vessel)

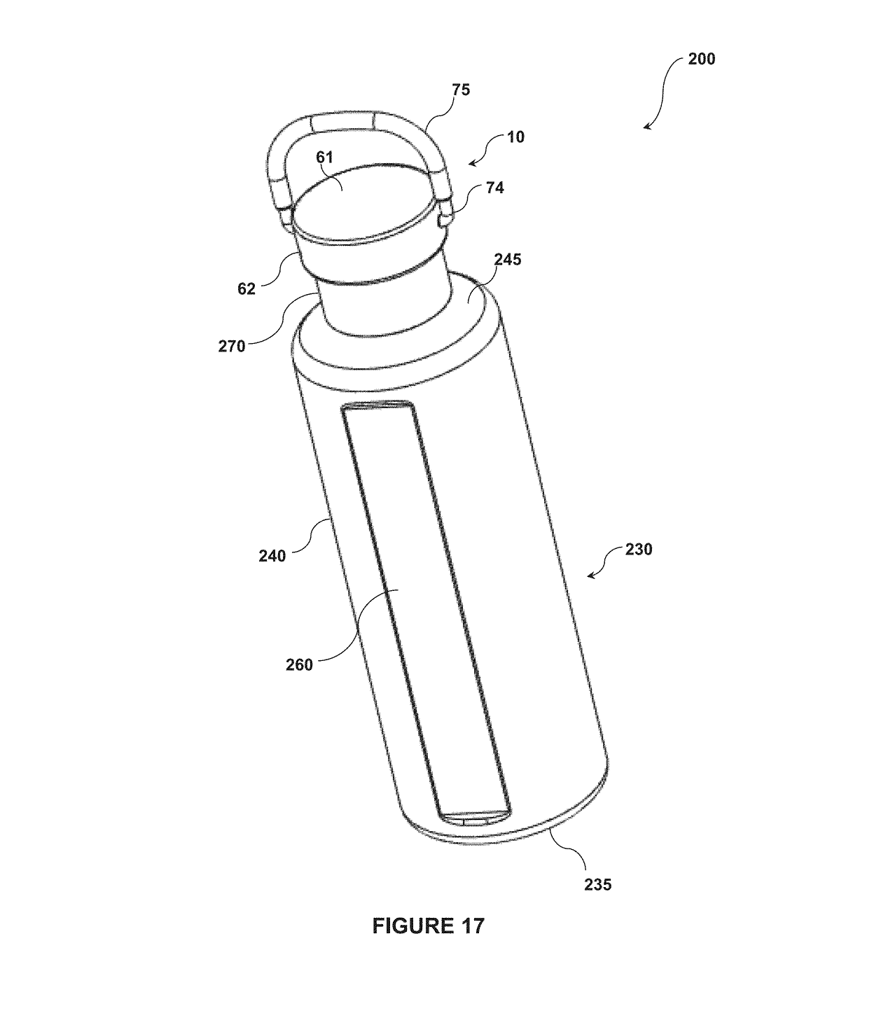

Referring to FIGS. 17 to 19 there is provided a container 200 according to another preferred embodiment of the present invention.

The container 200 comprises the cap device 10 described above, and a container body 230, whereby the body member 20 of the cap device 10 is configured for removably coupling to a neck 205 of the container body 230 to define a single-walled vessel.

The container body 230 takes the form of a generally circular base 235 and a wall 240 upstanding from the base 235 to define a generally cylindrical elongated body that slopes gently inwards to define a shoulder portion 245 that then terminates at the neck 205, being of a generally tubular form and having an outwardly rolled lip 210 at a terminal end portion thereof to ensure that the terminal end part of the material used in the manufacture of the wall 240, which may be sharp, is directed inwardly toward the external surface of the neck 205 for safety reasons.

The neck 205 defines an opening 215 that is sized to receive foodstuff and/or fluid substantially therethrough for the purpose of storing/transporting within an internal volume 250 that is defined by the base 235 and the wall 240 of the container body 230.

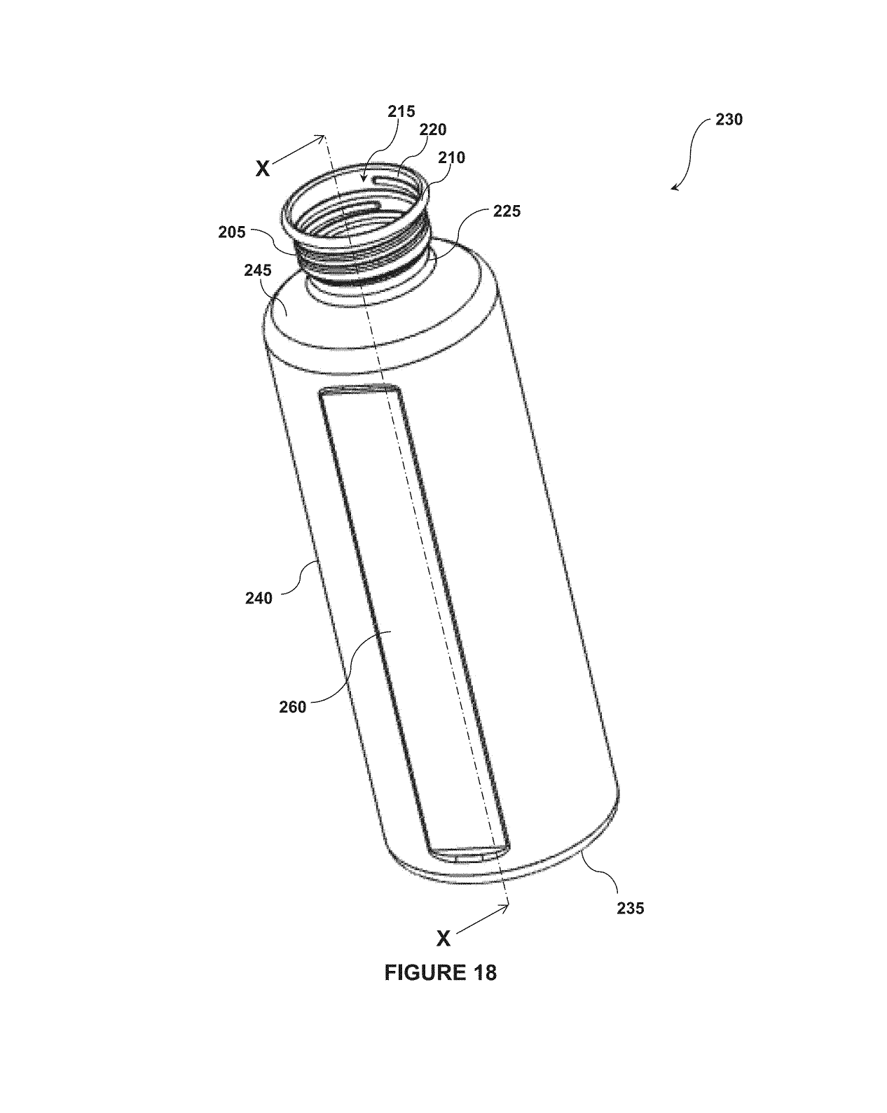

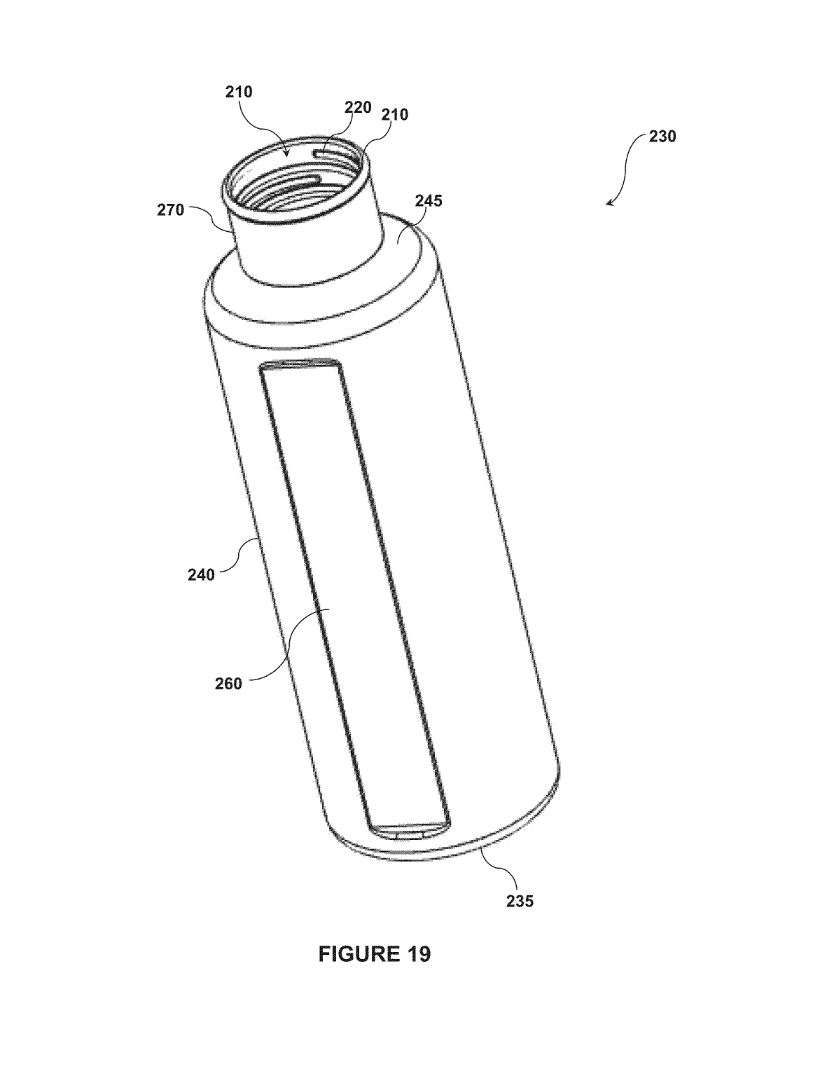

As shown in FIGS. 18 and 19, a screw thread 220 is formed at the inner surface of the neck 205 that is complementary to the screw thread 27 formed at the external surface of the lower body portion 22 of the body member 20.

As shown in FIG. 18, and schematically in FIGS. 20 and 21, the neck 205 of the container body 230 is specifically shaped at a lower end thereof, and below the internal screw threaded portion of the neck 205, to define a constriction 225 at the opening 215 that is of a narrower diameter to the rest of the neck 205. The purpose of the constriction 225 will become apparent from the partial cross sectional view (taken along a vertical plane X-X) of the container body 230 shown in FIG. 21, in which the lower portion 31 of the seal member 30 of the cap device 10 is suitably sized to engage with and be snugly received by the constriction 225 to form a watertight seal thereat.

In this arrangement, any foodstuffs and/or fluids for human consumption contained within the internal volume 250 of the container body 230 is precluded from bypassing the seal and contacting the plastic body member 20 of the cap device 10. To this end, any undesirable compounds associated with the manufacture of the plastic body member 20 have no opportunity to leach into the internal volume 250 of the container body 230 and contaminate the contents thereof.

For the purposes of the preferred embodiments of the present invention, it will be appreciated by persons of ordinary skill in the relevant art that the container body 230 of this single-walled vessel is required to be manufactured from a material that is devoid of potentially harmful compounds that may leach into the internal volume 250 of the container body 230. In this respect, the inventors have employed stainless steel, and more specifically, a food grade stainless steel such as 304 stainless steel or 316 stainless steel.

Recessed Portion

Optionally, the container body 230 may itself be modified for aesthetic and/or branding purposes.

For instance, and as shown in FIGS. 17 to 19, in one embodiment, the container body 230 is shaped to define a generally elongated portion 260 recessed into the wall 240 of the container body 230 and which extends generally from the base 235 to the shoulder portion 245. It will be appreciated that the recessed portion 260 may serve as means for branding purposes, whereby ornamentation such as an embossed (indented or raised) insignia or text can be formed into the wall 240 at the recessed portion 260 during the manufacturing process or indicia applied thereto post-processing. It will also be appreciated that the recessed portion 260 also provides a functional benefit in that it can serve as a means to aid a user holding the container body 230. This may be particularly beneficial in the case where the contents in the internal volume 250 are cold resulting in the formation of condensation on the external surface of the container body 230.

Sleeve

As shown in FIGS. 17 and 19, the container 200 further includes a generally cylindrical sleeve 270 that is applied around the external surface of the neck 205 of the container body 230, such that an upper portion of the sleeve 270 is located substantially beneath the outwardly rolled lip 210 of the neck 205 and a lower portion of the sleeve 270 is located substantially against the shoulder portion 245 of the container body 230. The sleeve 270 may be manufactured from any suitable metal or engineering plastic as required, where the choice of material largely dictates how the sleeve 270 is joined to the neck 205. It will be appreciated that the sleeve 270 is largely employed for aesthetic reasons to hide the ribbing at the external surface of the neck 205 caused by the formation of the internal screw thread 220. The sleeve 270 may also serve a branding purpose whereby ornamentation or indicia may be applied to the external surface of the sleeve 270.

Container (Double-Walled Vessel)

As described above, and as shown in FIGS. 17 to 19, the container body 230 is formed as a single-walled vessel for the purpose of storing/transporting foodstuffs and/or fluids, where the temperature of the foodstuffs and/or fluids contained within the internal volume 250 of the container body 230 is not a major concern.

However, it will be readily appreciated by those persons of ordinary skill in the art that where the temperature of the foodstuffs and/or fluids is of concern, then the container body can be manufactured as a double-walled vessel (not shown) having an insulation gap defined between an inner wall and an outer wall of the container body that is filled with either a partial vacuum or an insulating material such as insulating foam to provide hot and cold temperature insulation between the foodstuffs and/or fluids contained within the internal volume of the container body and the external environment.

Whilst not shown in any of the figures, the double-walled vessel is ideally formed by utilising the same single-walled container body 230 described above to define the inner wall, (inner) base, and neck 205 of the double-walled vessel. The outer walled part of the double-walled vessel takes the form of a container body (not shown) manufactured in much the same way as the single-walled container body 230, namely having a generally circular base and a wall upstanding from the base to define a generally cylindrical elongated body that slopes gently inwards to define a shoulder portion but without a neck. The dimensions of the as-formed cylindrical container body (hereinafter referred to as the outer container body) are larger than those of the single-walled container body 230 (hereinafter referred to as the inner container body) to allow the inner container body to be received within the outer container body and still define an insulation gap therebetween. The outer container body is then joined to the inner container body at the neck 205 using a suitable joining technique.

Since the outer container body of the double-walled vessel is unlikely to make contact with the foodstuffs and/or fluids contained within the internal volume 250 defined by the inner container body, then the outer container body can be made from a non-food grade metal or engineering plastic, provided that the metal or plastic chosen is sufficiently robust to maintain a partial vacuum in the insulation gap. In a preferred form, the outer container body is manufactured from stainless steel and joined to the food grade stainless steel inner container body at the neck 205 by welding.

### Advantages

The cap device 10 and container 200 according to the preferred embodiments of the present invention described above provide a number of benefits when combined in use, including, but not limited to:

1. Foodstuffs and/or fluids contained within the internal volume 250 of the container body 230 are precluded from contacting the plastic body member 20 of the cap device 20, thereby removing the potential for any undesirable compounds in the plastic body member 20 leaching into the internal volume 250 of the container body 230 to contaminate the foodstuffs and/or fluids.

2. The use of a food grade stainless steel in the manufacture of the body 230 of the container 200 precludes the need to apply a polymer lining to an internal wall of the container body 230, as would be necessary if aluminium was used in the manufacturing process instead. The absence of a polymer lining removes the potential for any undesirable compounds used in the manufacture of such polymer linings leaching into the internal volume 250 of the container body 230 that would contaminate the foodstuffs and/or fluids contained therein.

### Other Embodiments

It will be appreciated by those skilled in the relevant art that the embodiments of the present invention above are not limited to what has been described.

In other embodiments, it will be appreciated that the material used in the manufacture of the container body 230 is not limited to the food grade stainless steel described above, but may be an alternative alloy of stainless steel or even another metal entirely, such as copper, or suitable alloys thereof.

### Definitions

Whenever a range is given in the specification, for example, a temperature range, a time range, or concentration range, all intermediate ranges and subranges, as well as all individual values included in the ranges given are intended to be included in the disclosure. It will be understood that any subranges or individual values in a range or subrange that are included in the description herein can be excluded from the claims herein.

All definitions, as defined and used herein, should be understood to control over dictionary definitions, definitions in documents incorporated by reference, and/or ordinary meanings of the defined terms.

Throughout this application, the term “about” is used to indicate that a value includes the inherent variation of error for the device, the method being employed to determine the value, or the variation that exists among the study subjects.

The indefinite articles “a” and “an,” as used herein in the specification, unless clearly indicated to the contrary, should be understood to mean “at least one.”

The phrase “and/or,” as used herein in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the Figures. Spatially relative terms may be intended to encompass different orientations of the device in use or operation in addition to the orientation depicted in the Figures.

While the invention has been described in conjunction with a limited number of embodiments, it will be appreciated by those skilled in the art that many alternatives, modifications and variations in light of the foregoing description are possible. Accordingly, the present invention is intended to embrace all such alternatives, modifications and variations as may fall within the spirit and scope of the invention as disclosed.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

What is claimed is:

1. A cap device, including:
a body configured to allow the cap device to be removably coupled to a neck of a container body; and
a seal mounted to the body and configured to form a watertight seal at an opening of the neck when the cap device is coupled thereto to preclude a fluid and/or foodstuff contained within an internal volume of the container body from contacting the body.

2. A cap device according to claim 1, wherein the neck of the container body is shaped to define a constriction at the opening, and wherein the seal includes a lower portion configured to engage with and be snugly received by the constriction to form said watertight seal.

3. A cap device according to claim 1, wherein the body includes a lower body portion configured to engage the neck of the container body, wherein the neck and the lower body portion include complementary coupling means to allow the cap device to be removably coupled to the neck.

4. A cap device according to claim 3, wherein the complementary coupling means takes the form of a threaded portion disposed around an internal surface of the neck of the container body and a complementary threaded portion disposed around an external surface of the lower body portion for facilitating screw threaded engagement therebetween.

5. A cap device according to claim 3, wherein the seal includes an upper portion configured to engage with and be supported by the lower body portion.

6. A cap device according to claim 5, wherein the body is hollow and the upper portion of the seal is configured to locate within the lower body portion and be retained therein by an interference fit.

7. A cap device according to claim 6, wherein the seal further includes a recessed portion disposed substantially between the upper portion and the lower portion that is configured to receive a terminal end portion of the lower body portion by said interference fit.

8. A cap device according to claim 7, further including an insert configured to locate within the hollow body to engage with and cause the upper portion of the seal to abut against a ledge defined by the terminal end portion of the lower body portion according to said interference fit.

9. A cap device according to claim 8, further including a cap configured to mount to an upper body portion of the body to enclose the insert substantially within the hollow body between the cap and the seal.

10. A cap device according to claim 1, wherein the seal is manufactured from a food grade material.

11. A cap device according to claim 10, wherein the food grade material is a rubberised material selected from the group consisting of a silicone rubber and a fluoropolymer.

12. A cap device according to claim 1, wherein the body is manufactured from an engineering plastic material.

13. A cap device according to claim 12, wherein the engineering plastic material is selected from the group consisting of polypropylene, polyethylene, polyethylene terephthalate (PET), acrylonitrile butadiene styrene (ABS), polycarbonate and polyvinyl chloride.

14. A cap device according to claim 1, further including a handle operably coupled to the body.

15. A container, including:
a container body having a base and at least one wall generally upstanding from the base that terminates in a neck with an opening; and
a cap device having a body configured to allow the cap device to be removably coupled to the neck of the container body, and a seal mounted to the body and configured to form a watertight seal at the opening of the neck when the cap device is coupled thereto to preclude a fluid and/or foodstuff contained within an internal volume of the container body from contacting the body.

16. A container according to claim 15, wherein the neck of the container body is shaped to define a constriction at the opening, and wherein the seal includes a lower portion configured to engage with and be snugly received by the constriction to form said seal.

17. A container according to claim 15, wherein the body is manufactured from an engineering plastic material.

18. A container according to claim 17, wherein the engineering plastic material is selected from the group consisting of polypropylene, polyethylene, polyethylene terephthalate (PET), polycarbonate and polyvinyl chloride.

19. A container according to claim 15, wherein the seal is manufactured from a food grade material.

20. A container according to claim 19, wherein the food grade material is a rubberised material selected from the group consisting of a silicone rubber and a fluoropolymer.

21. A container according to claim 15, wherein the container body is manufactured from a food grade metal selected from the group consisting of stainless steel, copper, and any alloy thereof.

22. A container according to claim 15, wherein the container body is single walled.

23. A container according to claim 15, wherein the container body is double-walled.

24. A container according to claim 23, further including insulation material disposed substantially between the walls of the double-walled container body.

25. A container according to claim 23, further including a partial vacuum substantially between the walls of the double-walled container body.
